(19) United States
(12) Patent Application Publication
(10) Pub. No.: US 2024/0188534 A1
(43) Pub. Date: Jun. 13, 2024

(54) DEMOUNTABLE PET STAIRCASE

(71) Applicant: EZRA INNOVATION LIMITED, Kowloon (HK)

(72) Inventor: Eric Kong, Kowloon (HK)

(21) Appl. No.: 18/581,849

(22) Filed: Feb. 20, 2024

Related U.S. Application Data
(63) Continuation of application No. 17/553,749, filed on Dec. 16, 2021.

(51) Int. Cl. A01K 1/035

(52) U.S. Cl. CPC A01K 1/035

(57) ABSTRACT

A demountable pet staircase is formed by installing a step plate unit, a support plate unit and a cover, wherein the step plate unit comprises a starting baffle, treads, tread baffle, a roof and a back plate, the support plate unit is composed of side support plates and a bottom support plate, and the side support plate is connected with the bottom support plate as a whole. The assembler directly forms the structure of each unit by folding along the creases on the step plate unit and the support plate unit, splices through hook and loop fasteners and fixes the cover, so that the platelike pet stairs can be spliced into a pet staircase that can be directly used by pets. The demountable pet staircase is easily assembled and disassembled, and the platelike structures formed after disassembly are convenient to carry.

### CROSS-REFERENCE TO RELATED APPLICATIONS

This application is a Continuation of the U.S. application Ser. No. 17/553,749 filed on Dec. 16, 2021, and entitled “DEMOUNTABLE PET STAIRCASE”, now pending, the entire disclosures of which are incorporated herein by reference.

### TECHNICAL FIELD

The present disclosure relates to a pet staircase, in particular to a demountable pet staircase which can be directly spliced from the plate shape to provide pets with a staircase.

### BACKGROUND

With the improvement of people's living quality, more and more families choose to raise pets. In order to facilitate small sized pet dog or cats to move back and forth between high and low activity spaces or in the uneven outdoor environment, pet staircases specially for pets have appeared on the market. However, the volume of general pet staircases is too large, the manufacturers and shops often need to pack them into large boxes and deliver to customers. Moreover, most of the pet staircases on the market adopt a fixed structure, which are placed beside the sofas, windows or beds, which occupy large area of space, and can only be used as staircases. When the users disassemble them or need to take them outdoors, it takes up a lot of space to store them, increasing storage pressure.

### SUMMARY

The present disclosure aims to provide a demountable pet staircase. The assembler directly folds the structure of each unit along the creases on the step plate unit and the support plate unit, fixes and installs the step plate unit onto the support plate unit and puts on the cover, so that the platelike pet stairs can be spliced into a pet staircase that can be directly used by pets. The demountable pet staircase is easily assembled and disassembled, and the platelike structures formed after disassembly are convenient to carry.

A demountable pet staircase comprises starting baffles 11, treads 12, tread baffles 13, roofs 14, back plates 15, side support plates 21 and bottom support plates 22, which is characterized in that the pet staircase is composed of a step plate unit 1, a support plate unit 2 and a cover 3, wherein the step plate unit 1 is composed of a starting baffle 11, treads 12, a tread baffle 13, a roof 14 and a back plate 15, which form a panel with crease lines dividing the plane into the starting baffle 11, the tread 12, the tread baffle 13, the roof 14 and the back plate 15; the support plate unit 2 is composed of side support plates 21 and a bottom support plate 22, the side support plates 21 are connected to the left and right sides of the bottom support plate 22, the side support plates 21 and the bottom support plate 22 form a panel with crease lines, which divides the plane into the side support plates 21 and the bottom support plate 22.

The step plate unit 1 is composed of a starting baffle 11, treads 12, a tread baffle 13, a roof 14 and a back plate 15, which form a panel with crease lines dividing the plane into the starting baffle 11, the tread 12, the tread baffle 13, the roof 14 and the back plate 15, in which a plurality of treads 12 are arranged.

The side support plates 21 are connected to the left and right sides of the bottom support plate 22, the side support plates 21 and the bottom support plate 22 form a panel with crease lines, which divides the plane into the side support plates 21 and the bottom support plate 22.

The cover 3 is put on the installed step plate unit 1 and support plate unit 2, wherein the outer side of the cover 3 adjacent to the tread 12 of the step plate unit 1 can be made of plush wool or other materials.

Preferably, the side support plate 21 is provided with a tread support plate 24 and a roof support plate 23, the tread support plate 24 is placed at the lower end of the tread 12, and the roof support plate 23 is placed at the lower end of the roof 14. The tread support plate 24 and the roof support plate 23 are integrated with the side support plate 21, crease lines are arranged among the tread support plate 24, the roof support plate 23 and the side support plate 21, the tread support plate 24 and the roof support plate 23 can be laid onto the same plane as the side support plate 21 and can be folded in half along the crease line to the right-angle support structure of the side support plate 21 which supports the tread 12 or the roof 14.

Preferably, the step plate unit 1 is provided with a hook surface 31, the support plate unit 2 is provided with a loop surface 32, and the step plate unit 1 is connected with the support plate unit 2 by the fitting of hook surface 31 and loop surface 32. The hook and loop fastener is a fastening element which is commonly used in the field of furniture, is demountable and has good fixation property during fastening. By achieving the connection between the step plate unit 1 and the support plate unit 2 by the hook and loop fastener, the assembler can intuitively fasten or separate the step plate unit 1 and the support plate unit 2, thereby being easy to assemble and disassemble the pet staircase.

The step plate unit 1 and the support plate unit 2 can be installed and fixed through other common structures besides the hook and loop fasteners, specifically through buckles or magnets, etc.

### BRIEF DESCRIPTION OF THE DRAWINGS

FIG. 1 is a stereogram for a demountable pet staircase with a cover 3 removed in the present disclosure.

FIG. 2 is a stereogram for a demountable pet staircase of the present disclosure.

FIG. 3 is a stereogram for a step plate unit 1 of a demountable pet staircase in the present disclosure.

FIG. 4 is a top view for a step plate unit 1 of a demountable pet staircase in the present disclosure.

FIG. 5 is a stereogram for a support plate unit 2 of a demountable pet staircase in the present disclosure.

FIG. 6 is a top view for a support plate unit 2 of a demountable pet staircase in the present disclosure.

### DESCRIPTION OF THE EMBODIMENTS

The following is a further detailed description of the disclosure in combination with the drawings.

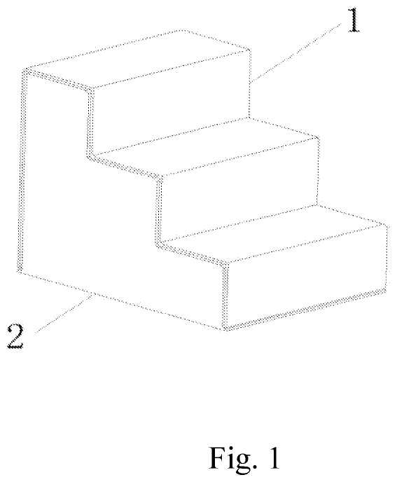

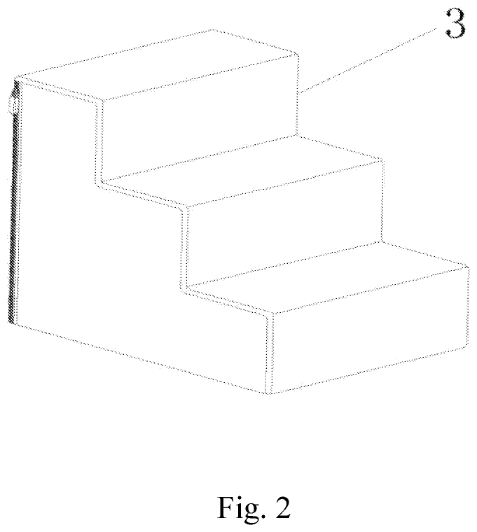

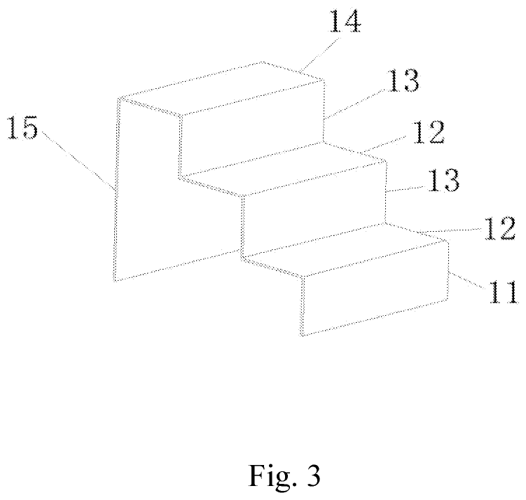

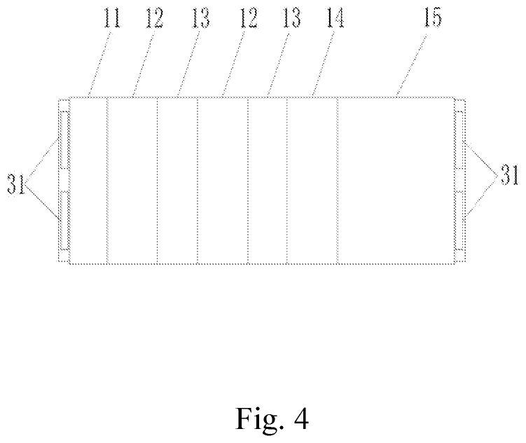

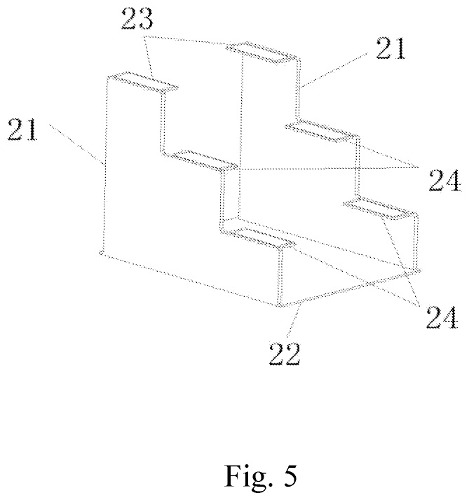

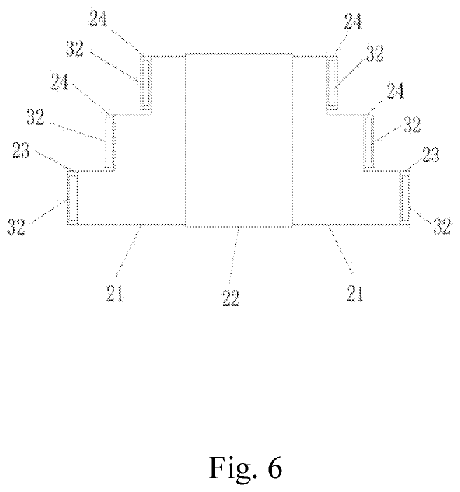

Refer to FIG. 1, FIG. 2, FIG. 3, FIG. 4, FIG. 5 and FIG. 6: when needing to install a demountable pet staircase of the disclosure, the assembler removes the components of each unit, and then folds in half along the crease lines of the step plate unit 1 to make the step plate unit 1 take on the structural shape of the starting baffle 11, the treads 12, the tread baffle 13, the roof 14 and the back plate 15; fold in half along the creases of the support plate unit 2 to make the support plate unit 2 take on the structural shape of the side support plate 21 and the bottom support plate 22. The step plate unit 1 is spliced with the support plate unit 2 through the hook and loop fastener, specifically, the hook and loop fastener on the tread 12 is fitted with the hook and loop fastener on the tread support plate 24, the hook and loop fastener on the starting baffle 11 is fitted with the hook and loop fastener on the bottom support plate 22, and the hook and loop fastener on the roof 14 is fitted with the hook and loop fastener on the roof support plate; the cover 3 is fixed, and the inner side of the cover 3 is closely fitted to the structures of the step plate unit 1 and the support plate unit 2 to complete the installation of the pet staircase.

Refer to FIG. 3 and FIG. 4. The step plate unit 1 and the support plate unit 2 arranged on the pet staircase are designed not to disassemble into a structure without a large occupying area and too many components. When the assembler needs to disassemble and fold the pet staircase, it is not easy to lose the components due to the relatively small quantity of components and they do not occupy large storage space.

When needing to disassemble the pet staircase after use, the assembler can disassemble the pet staircase into a platelike folding structure by disconnecting the hook and loop fastener connected between the step plate unit 1 and the support plate unit 2 and then laying the plates flat.

FIG. 5 is an embodiment of the disclosure in which a tread support 24 and a roof support plate 23 are arranged at the side support plate 21. The purpose of the tread support 24 and the roof support plate 23 is to expand the area of the support where the side support plate 21 is in contact with the tread 12 and the roof 14, increase the ultimate pressure of the side support plate 21 capable of supporting the tread 12 and the roof 14 and enhance the structural strength.

FIG. 4 and FIG. 6 are embodiments of the disclosure in which a hook and loop fastener is arranged between the step plate unit 1 and the support plate unit 2. The step plate unit 1 is provided with a hook surface 31, the support plate unit 2 is provided with a loop surface 32, and the step plate unit 1 is connected with the support plate unit 2 by the fitting of hook surface 31 and loop surface 32. Specifically, the hook surface 31 arranged on the starting baffle 11 is mutually fitted with the loop surface 32 arranged on the bottom support plate 22, the hook surface 31 arranged on the tread 12 is mutually fitted with the loop surface 32 arranged on the tread support plate 24, the hook surface 31 arranged on the roof 14 is mutually fitted with the loop surface 32 arranged on the roof support plate 25. By achieving the connection between the step plate unit 1 and the support plate unit 2 by the hook and loop fastener, the assembler can intuitively fasten or separate the step plate unit 1 and the support plate unit 2, so that the pet staircase can be easily assembled and disassembled in an intuitive way.

The present disclosure adopts one of the technical proposals: the fixation between the step plate unit 1 and the support plate unit 2 is realized through hook and loop fastener connecting accessories. Specifically, a hook surface 31 is arranged on the step plate unit 1. When the assembling, it can be seen from the installation structures of the step plate unit 1 and the support plate unit 2 that the hook and loop fastener arranged on the step plate unit 1 is on the back, so that the assembler can feel completely different texture from the step plate unit 1 when his/her fingers touch the hook surface 31 on the back, the assembler will remember this feature, so as to quickly learn that the area is the hook surface 31 and allow the hook and loop fastener to be fitted more accurately.

The step plate unit 1 and the support plate unit 2 can be installed and fixed through other common structures besides the hook and loop fasteners, specifically through buckles or magnets, etc.

The above embodiments are only the preferred embodiments of the disclosure. It should be noted that ordinary technicians in this field can make a number of variants and improvements on the premise of not deviating from the creative idea of the disclosure, which belong to the protection scope of the disclosure.

What is claimed is:

1. A demountable pet staircase, comprising
a step plate unit, and
a support plate unit connected to the step plate unit; wherein
each of the step plate unit and the support plate unit is an integrated structure and comprises a plurality of crease lines;
the plurality of crease lines partition the step plate unit into a starting baffle, at least one tread, at least one tread baffle, a roof and a back plate, and partition the support plate unit into a bottom support plate and two side support plates;
each of the step plate unit and the support plate unit is capable of being folded along the plurality of crease lines.

2. The demountable pet staircase according to claim 1, wherein each side support plate is provided with at least one tread support plate and a roof support plate, the at least one tread support plate is placed at a lower end of the at least one tread, and the roof support plate is placed at a lower end of the roof.

3. The demountable pet staircase according to claim 1, wherein the step plate unit is provided with a hook and loop fastener hook surface, the support plate unit is provided with a loop surface, and the step plate unit is connected with the support plate unit by fitting of hook and the loop fastener hook surface and the loop surface.

4. The demountable pet staircase according to claim 2, wherein each side support plate is integrated with the at least one tread support plate and the roof support plate.

5. The demountable pet staircase according to claim 1, further comprising a cover; wherein the cover is put on the step plate unit and the support plate unit; an outer side of the cover is made of plush wool.
